(19) United States
(12) Patent Application Publication
(10) Pub. No.: US 2020/0384400 A1
(43) Pub. Date: Dec. 10, 2020

(54) TOP INLET VACUUM PULSE CLEANING DUST COLLECTOR

(71) Applicant: Industrial Accessories Company, Mission, KS (US)

(72) Inventor: Luis Jorge Castano, Allentown, PA (US)

(73) Assignee: Industrial Accessories Company, Mission, KS (US)

(21) Appl. No.: 16/843,180

(22) Filed: Apr. 8, 2020

Related U.S. Application Data
(60) Provisional application No. 62/858,442, filed on Jun. 7, 2019.

(51) Int. Cl. B01D 46/00; B01D 46/04

(52) U.S. Cl. CPC B01D 46/0067; B01D 46/04

(57) ABSTRACT

A dust collector (10) includes upper and lower apertured tube sheets (40, 42) within a collector housing, with a plurality of vertically extending filter tube assemblies secured to upper tube sheet apertures (44) and extending downwardly toward the lower tube sheet (42). Each filter tube assembly (54) has a filter tube (56) optionally equipped with a lower weight assembly (58) placing the tube (56) in tension. Particulate-laden gas passes through the upper ends of the filter tubes (56) and downwardly therethrough, causing particulates to collect on the inner surfaces of the tubes (56). Such collected particulates are periodically removed by generating vacuum shock pulses which act on the tubes (56) to dislodge the particulates.

### CROSS-REFERENCE TO RELATED APPLICATION

This application claims the benefit of U.S. provisional application Ser. No. 62/858,442 filed Jun. 7, 2019, which is incorporated by reference herein in its entirety.

### BACKGROUND OF THE INVENTION

### Field of the Invention

The present invention is broadly concerned with top-inlet industrial dust collectors, such as baghouses, which direct particulate-laden gas (e.g., air) downwardly through filter tubes, causing particulate buildup on the interior surfaces of the filter tubes by virtue of passage of the incoming gas through the walls of the filter tubes. Built-up particulates are periodically removed by generating short-duration vacuum shock pulses which act on the filter tubes to thereby flex and distort the tubes so that the filtered dust is dislodged. The filter tubes may also be equipped with tubular weight elements in order to place the tubes in tension during operation and cleaning of the filter tubes.

### Description of the Prior Art

Industrial dust collectors (e.g., baghouses) are very commonly used to control air pollution in a large variety of facilities, such as power plants, steel mills, food, cement, lime, pharmaceutical manufacturing, and chemical factories. Generally speaking, these collectors are designed to remove particulates from process gas (e.g., air) which would otherwise be discharged to the atmosphere.

Industrial dust collectors may be classified by the method used to periodically clean the filter media employed therein. The three most common are mechanical shakers, reverse gas, and pulse jet.

In mechanical shaker designs, tubular filter bags are fastened onto a cell plate and suspended from upper support beams. Dirty gas enters the filter bags near the bottom thereof, passes upwardly so that dust collects on the inside surfaces of the media, and clean air passes through the media. During cleaning operations, the upper support beams are vibrated to shake off the collected dust particulates for collection.

In reverse-air collectors, dirty air enters the bottom of the filtering elements and passes upwardly to produce clean gas with particulates collected on the interiors of the elements. The elements are cleaned by injecting clean air in a reverse direction. This causes the bags to partially collapse, resulting in breaking of adhesive forces and removal of particulates, which fall into a hopper below.

Pulse jet collectors make use of individual bags supported by metal cages fastened to a cell plate at the top of the filter. Dirty air enters from the bottom and flows upwardly from the outside to inside of the bags, while the metal cages prevent collapse of the bags. The bags are cleaned by using short bursts of compressed air downwardly from a point above the upper ends of the bags. The compressed air is commonly accelerated by means of venturi nozzles located adjacent the bags. The short compressed air bursts travel the lengths of the bags and cause the bag surfaces to flex, resulting in dislodgement of the filtered particulates. These pulse jet filters remove the particulates more efficiently, so they require lower capital investments and presently dominate the market.

Notwithstanding the widespread use of pulse jet filters, these designs have a number of shortcomings. First, the necessary cages are expensive to make, ship, and are easily damaged during storage and handling. Moreover, cages are a major contributor of filter media failures, because they tend to create double-sided folds and wrinkles that reduce filtration areas and accelerate failures. Proper design requires critical (and hence expensive) bag filter-to-cage fits, because if clearances are not proper, the cage may not easily slide into a bag; on the other hand, if the cage is too loose, poor cleaning and premature failures may occur. Perhaps most important, cages lower the available filtration area presented by the filter bags. A typical 12-wire, 11-gauge cage for a 6-inch diameter filter bag blocks 8% of the available filtration area. A 20-wire cage blocks 13% of the filtration area. Bag-to-bag contact in pulse jet filters can also be a significant issue, particularly on long filter bag designs.

Conventional pulse jet filters are plagued by poor air flow distribution, particularly where incoming air is directed laterally into an array of bags. This results from the fact that the bag surfaces facing incoming flow of dirty air are more exposed to the air than the back sides of the bags and more remote bags. As a result, bags closer to the lateral dirty air inlet are subjected to greater filtering loads than the other bags.

Particulate reentrainment and “floaters” are endemic problems with pulse jet filters. Reentrainment occurs because incoming turbulent flow of dirty air sweeps a percentage of the removed particulates back to the filtration media. “Floaters” are submicron particles which can take more than 20 hours to settle in still air. Such “floaters” are not fully removed during pulsing, even with low interstitial velocities.

All of these factors present significant and heretofore unresolved problems in the art. The following are representative references: U.S. Pat. Nos. 3,095,289, 3,177,636, 3,765,152, 3,837,151, 3,999,968, 4,235,610, 4,648,889, 5,066,315, 6,511,637, 6,799,687, and 7,309,366; US Patent Publication No. 2006/0070360; foreign patent references Nos. CN106861305, EP0202066, GB1229952, and WO2013078164; and one non-patent reference, “Baghouse” found online at https://en.wikipedia.org/wiki/Baghouse.

### SUMMARY OF THE INVENTION

Improved dust collectors in accordance with the invention generally comprise an elongated, upright hollow filter tube presenting an open upper end and an open bottom end and formed of gas-pervious and substantially particulate-impervious material. Plenum or like structure is provided in order to pass particulate-laden gas (usually air) into the open upper end of the filter tube for passage downwardly along the length thereof, so that gas passes through the filter tube and particulates within the gas are collected on the inner surface of said filter tube. The collectors also include a system for periodically cleaning collected particulates from the interior of the filter tube, including apparatus located below the open bottom end of the filter tube serving to generate a vacuum shock pulse which acts on the filter tube to dislodge collected particulates. Generally, a dust collector will have a series of such filter tubes for handling large volumes of particulate-laden gas.

The cleaning system has an elongated tube extending downwardly below the open bottom of the filter tube, together with a device for generating a pulse of positive pressure gas directed downwardly away from the open bottom of the filter tube, in order to generate a vacuum shock pulse. The pulse-generating device advantageously includes a blow pipe extending laterally above or through the elongated tube, with an outlet opening for creating a pulse of positive pressure gas within the tube, which results in the desired vacuum shock pulse.

The filter tube may be equipped with a weight assembly coupled to the lower end thereof in order to place the filter tube in tension to thus enhance the cleaning effect. The weight assembly may be in the form of an elongated, open-ended pipe secured to the lower end of the filter tube.

The invention also provides a method of filtering dust using an elongated, upright hollow filter tube presenting an open upper end and an open bottom end, the filter tube formed of gas-pervious and substantially particulate-impervious material. This method involves the steps of passing particulate-laden gas into the open upper end of the filter tube for passage downwardly along the length thereof, so that gas passes through the filter tube wall, and particulates within the gas are collected on the inner surface of the filter tube. As needed and periodically, collected particulates are removed from the interior surface of the tube. This is accomplished by generating a vacuum shock pulse which acts on the filter tube in order to remove the collected particulates. As a consequence, the removed particulates gravitate downwardly and out the lower bottom end of the filter tube.

In another aspect of the invention, a dust collector is provided comprising upper and lower, apertured, vertically spaced apart tube sheets, with an elongated, upright hollow filter tube presenting an open upper end and an open bottom end and formed of gas-pervious and substantially particulate-impervious material extending between the tube sheets. Structure is provided to connect the open upper end of the filter tube to the upper tube sheet, and a tubular weight component is operatively secured adjacent the open bottom end of the filter tube, the weight component extending proximal to an aperture of the lower tube sheet. In preferred forms, a coupler is provided adjacent the lower end of the weight component, which is operable to connect the weight component to the proximal lower tube sheet aperture.

### BRIEF DESCRIPTION OF THE DRAWINGS

FIG. 1 is a perspective view of a dust collector in accordance with the invention;

FIG. 2 is an enlarged, fragmentary perspective view of the dust collector, with wall sections broken away to illustrate the internal components of the collector;

FIG. 3 is an enlarged, vertical sectional view illustrating the lower portion of one of the filter tube assemblies within the dust collector;

FIG. 4 is a partially exploded perspective view, with parts broken away, illustrating a complete filter tube assembly;

FIG. 5 is a view similar to that of FIG. 4, but illustrating the components of the filter tube assembly in exploded relation;

FIG. 6 is an enlarged, vertical sectional view similar to that of FIG. 3, but illustrating a filter tube assembly having a modified lower portion; and

FIG. 7 is an enlarged, vertical sectional view similar to that of FIG. 3, but illustrating a filter tube assembly having a modified lower portion, different than that illustrated in FIG. 6.

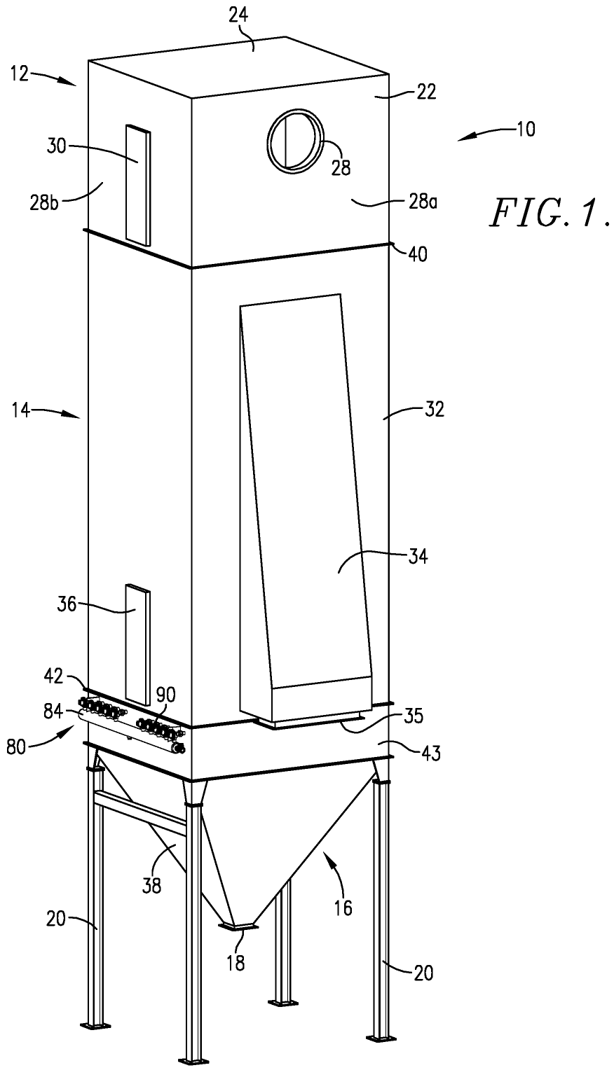

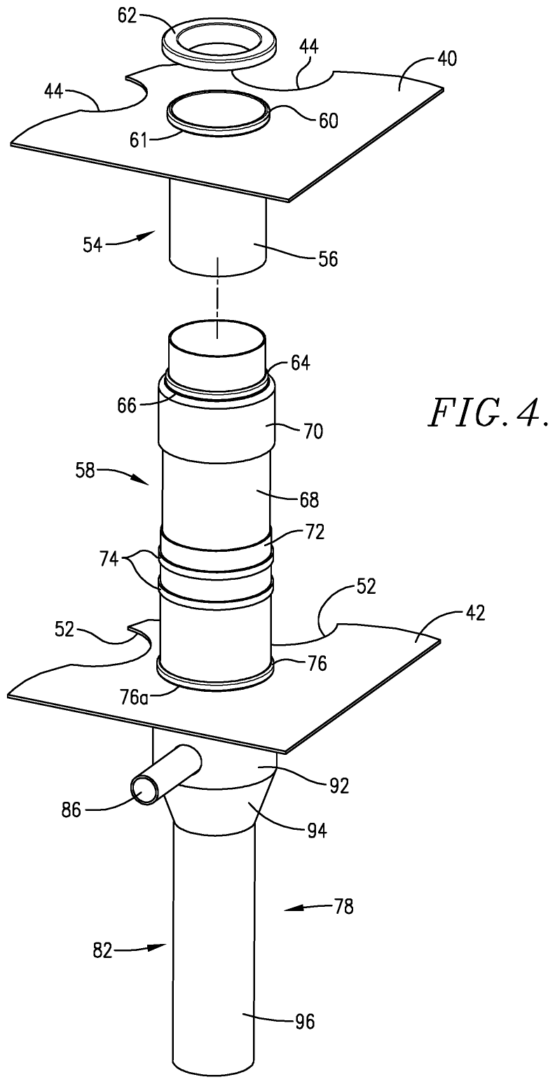

While the drawings do not provide exact dimensions or tolerances for the illustrated components or structures, FIGS. 1-7 are to scale with respect to the relationships between the components of the structures illustrated therein.

### DETAILED DESCRIPTION OF THE PREFERRED EMBODIMENT

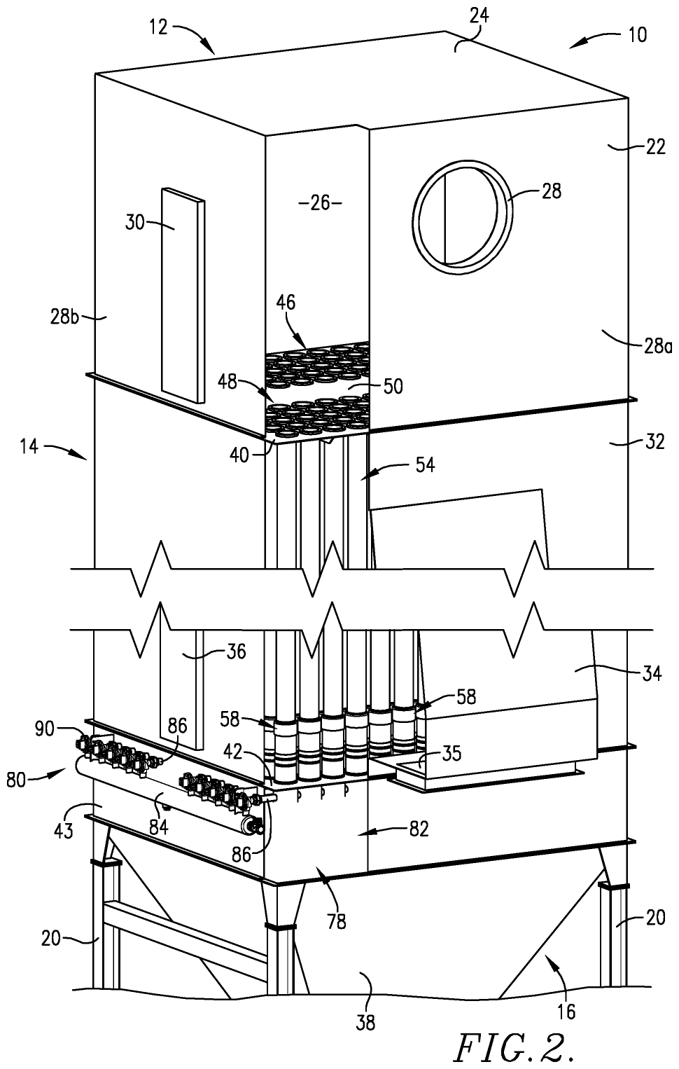

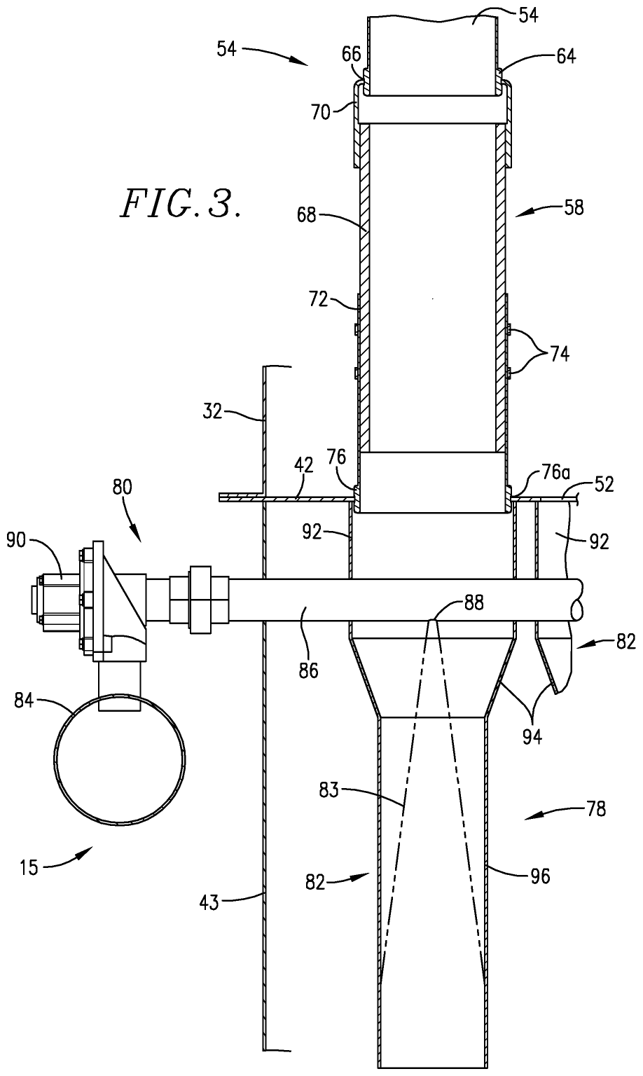

Turning now to the drawings, and particularly FIGS. 1-2, a complete dust collector 10 has a housing broadly includes an uppermost, particulate-laden incoming gas plenum section 12, a dust-filtering section 14, a filter cleaning system broadly referred to by the numeral 15 (see FIG. 3), and a lower particulate collection hopper 16 having a particulate discharge outlet 18. As illustrated, the collector housing is supported on upright legs 20 permitting access to the lower particulate discharge 18. The collector 10 is rectangular in plan configuration, but other shapes could be used, if desired.

The plenum section 12 includes upstanding sidewall structure 22 and a top roof 24, which define an internal plenum region 26. A particulate-laden gas inlet 28 is provided through the front panel 28a of sidewall structure 22 (of course, the inlet 28 may be located at any convenient location on roof 24 or sidewall structure 22), and an access door 30 is located in an adjacent sidewall panel 28b thereof.

The dust-filtering section 14 likewise has upright sidewall structure 32, as well as an outwardly extending, tapered clean gas outlet 34 having an open-bottom at 35. An access door 36 is also provided. The hopper 16 has converging walls 38, which taper toward particulate discharge 18.

Upper and lower tube sheets 40 and 42 are respectively located between the bottom margin of sidewall structure 28 and the bottom margin of sidewall structure 32. A bottom skirt wall 43 depends from tube sheet 42 and is attached to the upper end of collection hopper 16. The upper tube sheet 40 has a series of spaced apart openings 44 therethrough, which are located in rows, defining respective banks 46 and 48, with an access walkway 50 between the banks 46, 48. Likewise, the lower tube sheet 42 has a similar series of openings 52 therethrough, which are in alignment with the openings 44 of upper tube sheet 40.

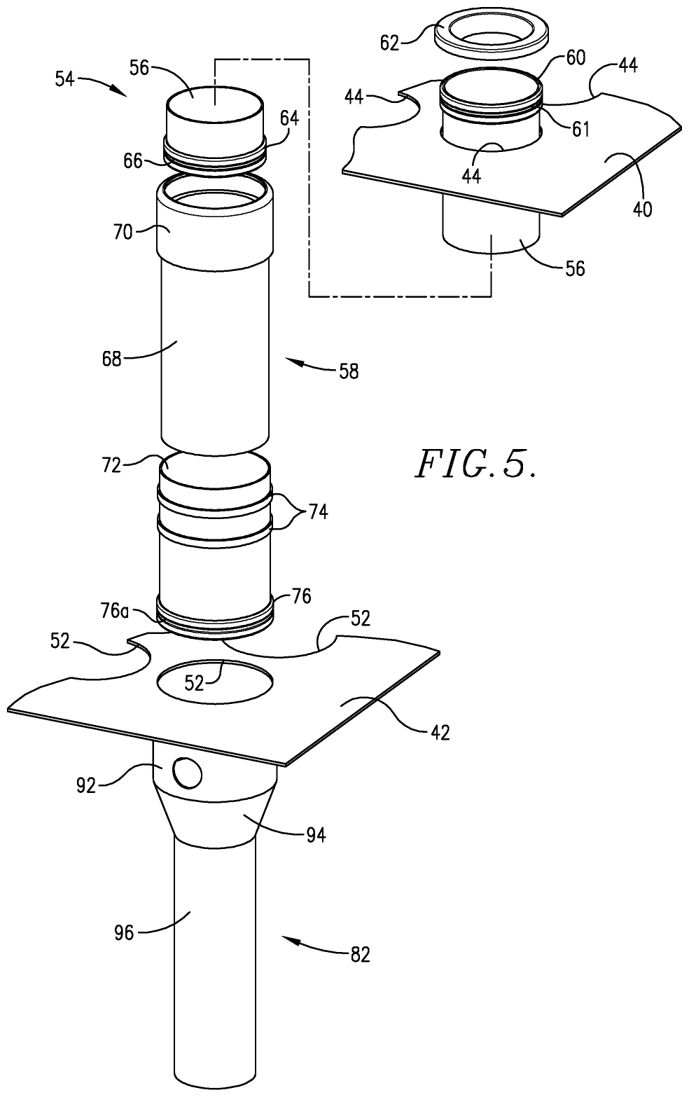

A series of filter tube assemblies 54 are located within section 14 and between the tube sheets 40, 42. Specifically, it will be observed that each filter assembly extends and is secured between aligned pairs of openings 44 and 52 in the tube sheets. Each tube assembly 54 includes a hollow, flexible, gas-pervious, substantially particulate-impervious filter tube 56 and a lowermost weight assembly 58 operable to place the tube in tension. In an embodiment, the filter tube 56 is formed of flexible fiberglass material with a polytetrafluoroethylene (PTFE) inner lining, but in other cases woven or felt materials can be used to fabricate the filter tubes; these tubes may also be pleated and/or equipped with internal stiffening rings. The upper end of tube 56 is secured to an opening 44 in sheet 40 by means of a resilient snap band 60 having an outer, peripheral, circumscribing groove 61, and a surrounding, annular wear guard 62. As illustrated, the opening 44 interfits with groove 61. The lower end of tube 56 is equipped with another resilient snap band 64 having an outer, peripheral, circumscribing groove 66 (FIG. 5).

The dust collectors of the invention generally have very favorable air-to-cloth (A/C) ratios, i.e., the amount of air going through each square foot of filter media per minute. These A/C ratios typically range from about 1-8 cfm/ft², more preferably from about 3-6 cfm/ft².

The weight assembly 58 comprises an elongated, tubular, imperforate metallic pipe 68; alternately, use can be made of other types of weight tubes formed of ceramic or like materials. A collar 70 fixedly secured by welding or otherwise to the upper end of pipe 68. The collar 70 has an upper end which fits within the groove 66, thereby suspending the pipe from the filter tube 56. The lower end of pipe 68 has a circumscribing connection boot 72, secured by means of band clamps 74 or other securing mechanisms. The extreme lower end of the boot 72 has a snap band 76 with a peripheral groove 76a, the latter interfitting with the aligned opening 52 in tube sheet 42.

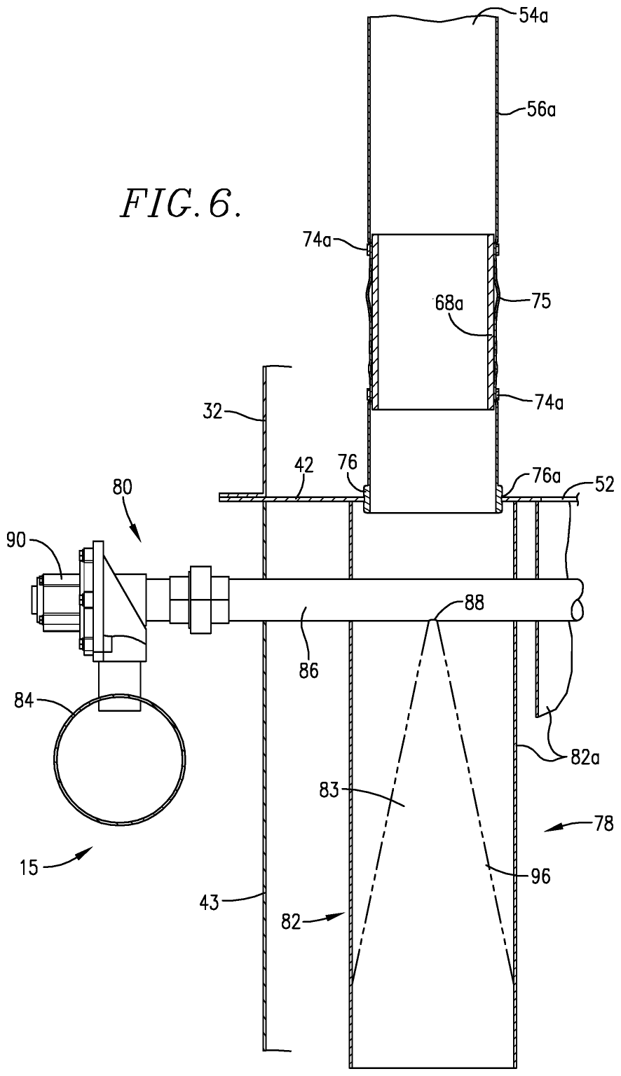

FIG. 6 depicts a modified filter tube assembly 54a, which differs from that of FIG. 3 in the provision of a modified weight assembly 58a serving to place the tube 56a in tension. In this embodiment, an elongated, solid, imperforate metallic pipe 68a is located within the confines of the tube 56a above bottom end thereof. This tube is positioned by means of one or more band clamps 74a, with a short, gathered section 75 of the tube 56a between the clamps 74a, which allows the tube 56a to eliminate filter tube slack. The lowermost end of the tube 56a is equipped with a snap band 76 with a peripheral groove 76a, the latter interfitting with the aligned opening 52 in tube sheet 42.

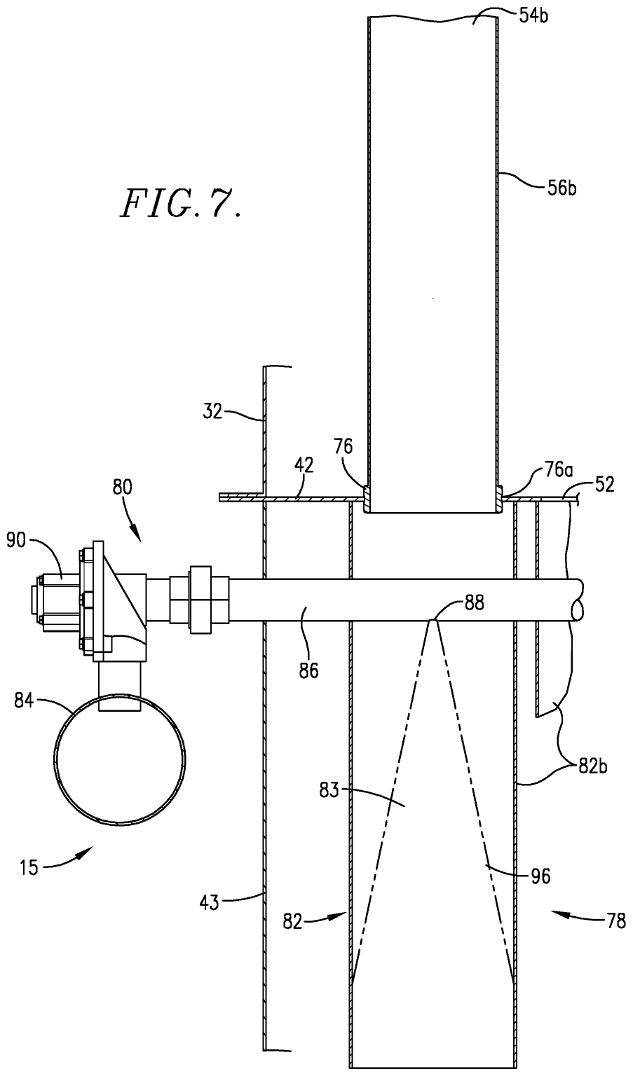

FIG. 7 depicts a still further modified tube assembly 54b, which entirely eliminates any weight assembly, so that the bottom margin of the tube 56b is equipped with a snap band 76 with a peripheral groove 76a, the latter interfitting with the aligned opening 52 in tube sheet 42.

The filter cleaning system 15 has a series of elongated tubes 78 located beneath the lower tube sheet 42, each located in axial registry with a corresponding tube assembly 54. Each assembly 78 includes a pressurized gas pneumatic unit 80 with a surrounding, tubular, open-ended tube 82 depending from the underside of tube sheet 42 in alignment with the above tube assembly 54. In an embodiment, the tube 82 is an imperforate body formed of metal. The unit 80 includes a common manifold 84 operatively coupled with a source of pressurized gas (not shown) and a series of blow pipes 86 coupled with the manifold 84. Each blow pipe extends laterally through a row of tubes 82 (see FIG. 3) and has a central, downward outlet opening 88 at the center of each tube 82 operable to generate a diverging, generally conical gas stream 83. An operating valve 90 is operably coupled to each blow pipe in order to control the operation thereof. Each tube 82 in the embodiment of FIGS. 1-5 has an apertured tubular upper section 92, a converging midsection 94, and a lowermost exhaust section 96.

In the embodiments of FIGS. 6 and 7, the tube 82a and 82b is simply a straight tubular section in lieu of the tube 82 of FIGS. 1-5, having the midsection 94.

### Operation

During filtering operations using the collector 10, particulate-laden or “dirty” gas is directed into plenum section 12 via a conduit (not shown) coupled with inlet 28. The pressure conditions within plenum 26 can be in the order of +6 to −50 inches of water column (wc), but more typically from about −3 to −20 inches. This dirty gas is then directed downwardly through the respective tube assemblies 54, where the gas encounters the filter tubes 56. The gas then passes through the sidewalls of the filter tubes, while the particulate content thereof builds up on the interior surfaces of the tubes. The pressure conditions within filter section 14 are normally on the order of −5 to −20 wc. This filtered or clean gas then passes out of the section 14 through the outlet 34. Any particulates remaining in the incoming gas pass downwardly into hopper 16 for collection.

When the interiors of the filter tubes 56 become coated with collected particulates to the point where there is an excessive pressure drop across the tubes, it is necessary to clean the tubes using the system 15. This is accomplished by directing a pulse of compressed or pressurized gas (at a pressure of from about 30-100 psi, more preferably from about 80-90 psi) through the blow tubes 86 to create the gas streams 83. This creates a pulse of negative pressure gas so that a vacuum shock is generated which acts upon the tube 56 on the inside thereof. Consequently, the tubes 56, 56a, and 56b are subjected to vibrations or shock waves serving to dislodge the collected particulates from the tube, which then fall aided by gravity and downward gas flow into hopper 16. In an embodiment, the pulse of positive pressure gas is generated for a period of from about 0.05 to 1 second, more preferably from about 0.1-0.2 second. The frequency of vacuum shock pulses can be at fixed intervals, or variable based upon the pressure drop across the filter tubes, which is primarily affected by dust-loading. Generally, the interval between vacuum shock pulses varies between about 10 seconds and several minutes. After such cleaning, the dust collector 10 continues normal filtering operations.

As noted, the filter tube assemblies 54 are connected to the upper and lower tube sheets 40 and 42. This tends to minimize or even eliminate any side-to-side movement of the tubes 56 and any tube-to-tube engagement.

### Calculations

Using a 6-inch diameter, 20-feet long filter tube at an air-to-cloth ratio of 4.5 cfm/ft², 141 cfm of air are processed per filter tube, or 0.23 ft.³ every 0.1 second. A 1½-inch double diaphragm pulse valve releases 4.2 ft.³ in 0.1 seconds at 90 psi (OEM specifications). Considering 14 filter tubes per pulse valve, 0.3 ft.³ of gas is suctioned from each tube in 0.1 second. Therefore, the amount of gas suctioned from each tube is 30% larger than the incoming flow to the tube, resulting in a momentary negative pressure shock to ripple the filter tubes and release filtered dust.

### EXAMPLE

A full-scale prototype baghouse in accordance with the invention was constructed for use at a shot blast booth. The prototype used 140 filter tubes of 6-inch diameter and 20-feet length, sized at an air-to-cloth ratio of 4.54 cfm/ft², for a capacity of 20,000 cfm. After several hours of operation and injection of significantly more dust than a normal process generates, maximum pressure differentials of up to 3.3 inches w.g. were observed. The vacuum pulse filter tube cleaning system was activated (80 psi, 120 ms on-time), and in a few minutes, the differential pressure was lowered to 2 inches w.g., establishing that the vacuum shock cleaning system worked very well.

### Operational Advantages

The prototype baghouse confirms that the invention redefines baghouse performance and maintenance expectations. These advantages include:
Faster and safer maintenance—Elimination of large top doors, blow pipes, and cages reduces the manpower needed for filter tube replacements; also, owing to the fact that the filtered dust is collected on the insides of the filter tubes, it is much less hazardous to handle used filter tubes for disposal. Any dust accumulations on the upper tube sheets can be easily cleaned off by simple brooming.
Elimination of cages—Apart from the cost of conventional cages, the present invention eliminates secondary problems, including sharp filter media flex points, high shipping and handling costs, and excessive man-hours required for tube replacements. Other eliminated cage issues include partial filter media blockage, top space requirements, and a need for large top access doors, the latter sometimes requiring penthouse structures and hoists. The lack of cages provides about 8-13% more available filter media area. Side-to-side movement of the filter tubes and consequent tube-to-tube engagement are minimized or even eliminated, owing to the fact that the upper and lower ends of the filter tubes are connected to tube sheets. Hence, the absence of cages eliminates bag wear from cage corrosion, stuck cages, the need for static electricity grounding in the presence of combustible dusts, and extra cage handling.
Lower maintenance and operational costs—Longer filter tubes can be used without interstitial velocity concerns, which reduce baghouse footprints and investments. Elimination of large doors, cages, and blow pipes provides savings in maintenance costs.
Maximized use of filtration area—By uniformly distributing incoming gas flow to all filter tubes, eliminating bag-to-bag contact, and building uniform dust coating through the length of the filter tubes, maximum available filtration area may be utilized. This results in fewer cleaning cycles and longer filter tube life.
No interstitial (rising) or horizontal flow velocities—This feature makes the invention suitable for filtering very fine or light materials. ASME tests show that 1.5-micron particles take 20 hours to settle 10 meters in still air, so that such “floater” particles may not be removed with conventional equipment. However, the present invention provides incoming flow, gravity, and cleaning action all in the same direction, so that fine particles may be removed as efficiently as coarse particles.
Compressed air released away from filter media—In the present invention, compressed air is directed away from the filter tubes, reducing the likelihood of flow-blocking nodule formation on the filter media, especially in humid conditions. Also, vacuum shock dust removal acts directly on the dust cake, and is not muffled or otherwise impeded by the filter media itself.
Elimination of material dropout at the inlet allows maximum reagent effectiveness in dry sorbent injection (DSI) applications—When using lime, activated carbon, or specialized sorbents, the present invention forces such injected reagents through the filter tubes, maximizing the effectiveness thereof.

It will thus be seen that the present invention provides greatly improved apparatus and methods for industrial dust collection, particularly in the context of baghouses, which entirely eliminates the need for mechanical bag shaker devices, bag-supporting cages, and the use of positive pressure pulse-jet arrangements positioned at the upper inlet ends of bags, as in the case of conventional pulse jet baghouse designs.

I claim:

1. A dust collector comprising:
an elongated, upright hollow filter tube presenting an open upper end and an open bottom end and formed of gas-pervious and substantially particulate-impervious material;
structure operable to pass particulate-laden gas into the open upper end of said filter tube for passage downwardly along the length thereof, so that gas passes through the filter tube and particulates within the gas are collected on the inner surface of said filter tube; and
a system for periodically cleaning collected particulates from the interior of said tube, including apparatus located below the open bottom end of said filter tube in order to generate a vacuum shock pulse which acts on said filter tube so as to dislodge collected particulates.

2. The dust collector of claim 1, said system comprising an elongated tube extending downwardly below the open bottom of said filter tube, and a device for generating a pulse of positive pressure gas directed downwardly away from the open bottom of said filter tube, in order to generate said vacuum shock pulse.

3. The dust collector of claim 2, said device comprising a blow pipe extending through above or through said elongated tube and having an outlet opening for positive pressure gas within said tube.

4. The dust collector of claim 1, including a weight assembly operably coupled to the lower end of said filter tube, in order to place the filter tube in tension.

5. The dust collector of claim 4, said weight assembly comprising a tubular pipe operably connected to said filter tube adjacent the lower bottom end thereof

6. The dust collector of claim 1, said structure comprising a plenum above the upper open end of said filter tube for receiving said particulate-laden gas and for directing the particulate-laden gas downwardly through said filter tube.

7. A method of collecting dust using an elongated, upright hollow filter tube presenting an open upper end and an open bottom end, said filter tube formed of gas-pervious and substantially particulate-impervious material, said method comprising the steps of:
passing particulate-laden gas into the open upper end of said filter tube for passage downwardly along the length thereof, so that gas passes through the filter tube and particulates within the gas are collected on the inner surface of said filter tube;
periodically removing collected particulates from the interior surface of said tube, including the step of generating a vacuum shock pulse which acts on said filter tube in order to remove said collected particulates; and
causing the removed particulates to travel downwardly and out the lower open bottom of said filter tube.

8. The method of claim 7, said particulate removal step comprising the step of generating a pulse of positive pressure gas directed downwardly away from the open bottom of said filter tube and into an elongated tube, to thereby create said vacuum shock pulse.

9. The method of claim 8, including the step of directing a pulse of positive pressure gas through a blow pipe extending above or through said elongated tube and having an outlet opening for positive pressure gas within said elongated tube.

10. The method of claim 7, including the step of placing said elongated filter tube in tension.

11. The method of claim 10, including the step of attaching a weight assembly comprising a tubular pipe to said filter tube adjacent the lower bottom end thereof

12. The method of claim 7, including the steps of directing said particulate-laden gas into a plenum above the upper open end of said filter tube, and causing the particulate-laden gas within the plenum to pass downwardly through said filter tube.

13. The method of claim 7, said gas comprising air.

14. A dust collector comprising:
upper and lower, apertured, vertically spaced apart tube sheets;
an elongated, upright hollow filter tube presenting an open upper end and an open bottom end and formed of gas-pervious and substantially particulate-impervious material;
structure connecting the open upper end of said filter tube to said upper tube sheet; and
a tubular weight component operatively secured adjacent the open bottom end of said filter tube, said weight component extending to a point proximal to an aperture of said lower tube sheet.

15. The dust collector of claim 14, including a coupler adjacent the lower end of said weight component and operable to connect the weight component to said proximal lower tube sheet aperture.

16. The dust collector of claim 14, including:
structure for passing particulate-laden gas into the open upper end of said filter tube for passage downwardly along the length thereof and through said tubular weight component, so that gas passes through the filter tube and particulates within the gas are collected on the inner surface of said filter tube; and
a system for periodically cleaning collected particulates from the interior of said tube, including apparatus located below said weight component in order to generate a vacuum shock pulse which acts on said filter tube in order to dislodge said collected particulates.
